(19) United States
(12) Patent Application Publication
(10) Pub. No.: US 2020/0134592 A1
(43) Pub. Date: Apr. 30, 2020

(54) SYSTEMS AND METHODS FOR VEHICLE SHARING ON PEER-TO-PEER NETWORKS

(71) Applicant: Ford Global Technologies, LLC, Dearborn, MI (US)

(72) Inventors: Prashant Rao, Dearborn, MI (US); Abhishek Sharma, Ann Arbor, MI (US); Amanuel Zeryihun, Pinole, CA (US); Pramita Mitra, West Bloomfield, MI (US); David Melcher, Ypsilanti, MI (US)

(73) Assignee: Ford Global Technologies, LLC, Dearborn, MI (US)

(21) Appl. No.: 16/172,680

(22) Filed: Oct. 26, 2018

(51) Int. Cl. G06Q 20/22; G06Q 10/02; G06Q 50/30; H04L 9/06; H04L 9/32; G06Q 20/06

(52) U.S. Cl. CPC G06Q 20/223; G06Q 10/02; G06Q 50/30; H04L 2209/56; H04L 9/3236; G06Q 20/065; H04L 2209/38; H04L 9/0637

(57) ABSTRACT

Systems, methods, and computer-readable media are disclosed for vehicle sharing on peer-to-peer networks. Example methods may include determining, by one or more computer processors coupled to at least one memory an input indicative of an environment context of a user, an input indicative of a user request associated with a vehicle. The example methods further include determining a vehicle option or a service option based on the input, accessing a file associated with transactions on a peer-to-peer network including computing nodes connected based on a blockchain protocol, and adding information associated with the user the vehicle option or service option to the file.

### TECHNICAL FIELD

The present disclosure relates to systems, methods, and computer-readable media for vehicle sharing on networks.

### BACKGROUND

Users may be interested in finding and obtaining various vehicles for transportation. For example, users may be interested in obtaining a ride between their work location and a given destination, without advanced scheduling. A user may use a vehicle ridesharing, taxi cab, bicycle-sharing, or transportation network service to obtain a ride. However, such services may not necessarily have optimal coverage or meet the requirements of all users under different scenarios.

### BRIEF DESCRIPTION OF THE DRAWINGS

FIG. 1 shows a diagram of an example system architecture, in accordance with example embodiments of the disclosure.

FIG. 2 shows a diagram of an example application and process flow, in accordance with example embodiments of the disclosure.

FIG. 3 shows a diagram of an example business process flow, in accordance with example embodiments of the disclosure.

FIG. 4A shows a diagram of an exemplary system for peer-to-peer vehicle sharing including a cryptocurrency payment network, in accordance with example embodiments of the disclosure.

FIG. 4B shows a diagram of an exemplary system for peer-to-peer vehicle sharing including a cryptocurrency payment network, in accordance with example embodiments of the disclosure.

FIG. 5 shows a diagram illustrating a blockchain, in accordance with example embodiments of the disclosure.

FIG. 6 is a functional diagram illustrating details of each block and transaction in the blockchain of FIG. 5, in accordance with example embodiments of the disclosure.

FIG. 7 shows a flowchart, in accordance with example embodiments of the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In various environmental contexts, various resources may become scarce. For example, in some disaster-zones (natural or man-made), a city's resources may become limited; accordingly, there may not be sufficient supply of a given resource such as personnel, vehicles, and/or associated services (e.g., towing, equipment delivery and pickup, emergency aid distribution, and the like). Natural disasters may refer to major adverse event resulting from natural processes of the Earth; non-limiting examples may include floods, hurricanes, tornadoes, volcanic eruptions, earthquakes, tsunamis, and other geologic processes. Man-made disasters may include adverse events resulting from human activity, including, but not limited to, terrorism, war, cyber warfare, economic disasters, and the like. A disaster can cause loss of life or property damage, and may leave some economic damage in its wake, the severity of which depends on the affected population's resilience, or ability to recover and also on the available infrastructure.

In particular, during such situations, a particular type of vehicle, such as a utility vehicle (e.g., a snow plow, emergency medical service (EMS) vehicle, a truck, and the like) may be in short supply, while corresponding demand levels for such vehicles may be relatively high. Additionally, there may be a particular demand for a specific type of vehicle (e.g., a utility vehicle) from individual manufacturer (e.g., an original equipment manufacturer) vehicle owners needing particular services (e.g., an owner of an individual manufacturer's sedan vehicle who may need help with moving, or who may need help with removal of a fallen tree, and the like). Accordingly, embodiments of the disclosure may match requesters with vehicles and services. Further, embodiments of the disclosure may result in an increase of brand loyalty, monetization, and brand presence of a given individual manufacturer by creating a community and corresponding network of vehicle owners, dealers and associated organizations that can help provide services within this network and/or a partnership ecosystem.

In various aspects, disclosed herein include systems, methods, and apparatuses for a blockchain-based local peer-to-peer network for individual users and groups of users to share vehicles and associated on-demand services (e.g., a network for requesting and providing personally-owned special utility vehicles). For example, a given manufacturer's pickup truck owner may share the vehicle and one or more associated services (e.g., delivery of food and equipment or pickup of debris) to support a given city's department of transportation or fire department during an environmental event, such as during a snow storm.

In one embodiment, a vehicle owner may increase a net utilization of one or more vehicles that they own and may furthermore advertise the services that they can provide, thereby serving as a service provider in the peer-to-peer network. Alternatively or additionally, a given vehicle owner or simply another user (not necessarily a vehicle owner) may request a given vehicle of a certain type and/or choose a corresponding service that matches the vehicle owner's preferences, thereby acting as a client in the peer-to-peer network. In one embodiment, both entities (e.g., service providers and clients) can interact with the peer-to-peer network asynchronously. In another embodiment, autonomous vehicles (AVs) (e.g., general AVs such as sedans and/or specialized AVs such as trucks or utility vehicles) may be used by the clients, for example, to transport goods and people, and may facilitate the integration of associated services. In another embodiment, the use of such AVs may help fleet managers for a given company to increase utilization of their fleet of vehicles. Moreover, embodiments of the disclosure may enable AVs to request a given service when the AV has a particular need (e.g., when the AV needs towing, it can automatically bid for such a service in the local peer-to-peer network).

In further embodiments, the communications and informational exchanges that happen in the network may be based on and enabled by a blockchain protocol. Moreover, payment for the services may be enabled by the blockchain protocol, for example, in the form of token exchange (e.g., using cryptocurrencies or other forms of rewards tokens such as points tied to a given manufacturer).

In one embodiment, the disclosed systems, methods, and apparatuses as viewed from the service provider side, may enable individual users or groups of users (e.g., vehicle owners and/or service providers) having available time and resources to offer their service and products (e.g., vehicles) in an environmental context that may define a micro-economy. Further, embodiments of the disclosure may incentivize small communities to be more independent and less reliant on the governmental organizations and other third parties during an emergency or disaster. Further, embodiments of the disclosure may be useful for owners of certain types of vehicles (for example, large vehicles, like vans) who can offer their vehicles and associated services for use as EMS vehicles, delivery vehicles, and the like.

As noted, embodiments of the disclosure may be used in a given environmental context such as during emergencies, where it may be better for vehicles available at hand (e.g., a given county or city area) to carry out a task rather than wait for specialized vehicles to arrive from a central dispatch location. In another embodiment, embodiments of the disclosure may enable one or more third-party entities that are affiliated with a given company's ecosystem to communicate in the peer-to-peer network operating under blockchain technologies, and thereby help an underlying micro-economy and associated community to grow. In another embodiment, the disclosed systems, methods, and apparatuses as viewed from the client side, may enable reduced service times by leveraging a local, peer-to-peer network, while helping a micro-economy grow in a given community (e.g., a rural or urban community).

Various terms used throughout the specification and/or claims are defined below. In particular, in an embodiment, “blockchain” or “blockchain” may refer to a distributed database that keeps a growing list of data records. In another embodiment, each data record may be protected against tampering and revisions. blockchains may be used in association with public ledgers of transactions, and the record may be protected cryptographically.

In another embodiment, “computing node” may refer to a computational device with an internal address that can host a copy of a blockchain and the associated transactions, for example, as a part of a peer-to-peer network.

In one embodiment, a “hash function” may refer to a mathematical algorithm that may map an arbitrarily-large amount of data into a fixed-length size. In one embodiment, a given hash will always result from the same data, but modifying the data (e.g., changing a bit of the data) may change the hash. The values returned by the hash function are called a “hash”.

In one embodiment, “public ledger” may refer to a publicly accessible listing of transactions for the distributed database or blockchain.

In another embodiment, “digital currency” may refer to units of value that may be used as a form of payment for transactions, including financial transactions. Digital currency may include currency that is electronically generated by and stored within a computing device. Digital currency may be purchased using conventional forms of currency (e.g., flat currency such as dollars or Euros) and generated with a specific value. Typically, the digital currency may not have a physical form of tender but may be accessible through a user computing device (e.g., mobile device) using a software application such as a digital wallet or mobile application.

In one embodiment, a “cryptocurrency payment network” may refer to one or more server computers that function to operate and maintain a cryptocurrency system. The cryptocurrency payment network may function to facilitate the generation/issuance and distribution of digital currency between the one or more server computers within the cryptocurrency payment network. The cryptocurrency payment network may also function to enable the performance of transactions between the server computers for the transfer or goods/services and/or the transfer of funds.

In the context of cryptocurrency systems, the term “node” may refer to a computing device within the cryptocurrency system. A node in a cryptocurrency system may be associated with and/or operated by a financial institution server computer of a financial institution (e.g., bank). Each node may have particular rights and restrictions associated with the node. For example, an issuer node may have the right to generate and issue digital currency within a cryptocurrency payment network, while a distributor node may have the right to distribute digital currency, but not generate or issue digital currency. Other nodes in the cryptocurrency payment network, such as merchants and users (e.g., consumers), may have the right to transfer digital currency.

In one embodiment, a “ledger of transactions” may refer to a compilation of data from previous transactions. The ledger of transactions may be a database or other comparable file structure that may be configured to store data from all previous transactions performed using a digital currency, including the date and time of the transaction, the transaction amount, and the participants of the transaction (e.g., the sender and the receiver of the transaction amount). In some embodiments, the ledger of transactions may include at least part of a blockchain, where a new block in the blockchain is algorithmically determined based on new transactions and previous blocks in the block chain. In some embodiments, each node within a cryptocurrency payment network may store their own copy of the ledger of transactions. In other embodiments, only some nodes may store their own copy of the ledger of transactions.

In one embodiment, a “digital certificate” may refer to data used as part of a verification process. A digital certificate may be used to send information to from one entity to another entity. The digital certificate may be used to verify that the entity sending a message is authentic. In some embodiments, a digital certificate may include data indicating a digital certificate version, a serial number, an algorithm identifier, a name of the issuing certificate authority (e.g., a management system), an expiration date, a copy of the node verification public key, and the digital signature of the issuing certificate authority so that a recipient (e.g., the node) can verify that the certificate is authentic.

In one embodiment, “digital signature” may refer to an electronic signature for a message. In some embodiments, the digital signature may be used to validate the authenticity of a transaction message sent within a cryptocurrency payment network. A digital signature may be a unique value generated from a message and a private key using an encrypting algorithm (e.g., a Rivest-Shamir-Adleman, RSA, algorithm). In some embodiments, a decrypting algorithm using a public key may be used to verify the signature. The digital signature may include, but not be limited to, a numeric value, an alphanumeric value, or any other type of data including a graphical representation.

In one embodiment, “key” may refer to a piece of data or information used for an algorithm. A key may be a unique piece of data and is typically part of a key pair where a first key (e.g., a private key) may be used to encrypt a message, while a second key (e.g., a public key) may be used to decrypt the encrypted message. The key may be a numeric or alphanumeric value and may be generated using an algorithm. A management system server computer in a cryptocurrency payment network may generate and assign a unique key pair for each node in the cryptocurrency payment network. In some embodiments, a key may refer to either a node verification key pair or a transaction key pair.

A transaction key pair may include a transaction public key and a transaction private key. The transaction key pair may be used by the nodes and/or payment entities to conduct transactions in the cryptocurrency payment network. The transaction key pair may be generated by one or more user devices (e.g., a server device, a mobile device, etc.) or may be generated by third-party device (e.g., a financial institution server computer) for a payment entity when an account with a given financial institution server computer is created. The transaction public key of a node may be distributed throughout a cryptocurrency payment network in order to allow for authentication of payment transaction messages signed using the private key of the node.

Further, a node verification key pair may include a node verification public key and a node verification private key. The node verification key pair may be used by the nodes and the management system to verify that a node is an issuer node or a distributor node. The node verification key pair may be generated by a given device (e.g., a management system server computer) in response to a request message from a node to be designated an issuer node or a distributor node in the cryptocurrency payment network. In other embodiments, the node verification key pair may be generated by a node (e.g., a financial institution server computer) and sent to the management system server computer. In some embodiments, a node verification public key may be functionally similar to a transaction public key. However, the node verification public key may only be distributed to the node associated with the node verification public key. In such embodiments, the node verification public key may be encrypted prior to being sent to the appropriate node.

In one embodiment, a “user device” or “user computing device” may refer to a computing device that is associated with a user. In some embodiments, the user computing device can be used to communicate with another device, computer, or system. It can include a user computing device that is used to conduct a transaction. The user computing device may be capable of conducting communications over a network. A user computing device may be in any suitable form. For example, suitable user computing devices can be hand-held and compact so that it can fit into a user's wallet and/or pocket (e.g., pocket-sized). The user computing device can include a processor, and memory, input devices, and output devices, operatively coupled to the processor. Specific examples of user computing devices include cellular or mobile phones, tablet computers, desktop computers personal digital assistants (PDAs), pagers, portable computers, smart cards, and the like. Additional user computing devices may include wearable devices, such as smart watches, glasses fitness bands, ankle bracelets, rings, earrings, etc. In some embodiments, the user computing device may include automobiles with remote communication capabilities.

In one embodiment, an “identifier” may refer to any information that may be used to identify information. In some embodiments, the identifier may be a special value generated randomly or according to a predetermined algorithm, code, or shared secret. For example, an account identifier may be used to uniquely identify an account. In some embodiments, the identifier may be one or more graphics, a token, a bar code, a QR code, or any other information that may be used to uniquely identify an entity.

In another embodiment, a “transaction” may include an exchange or interaction between two entities. In some embodiments, a transaction may refer to a transfer of value between two users (e.g., individuals or entities). A transaction may involve the exchange of monetary funds (e.g., digital currency), or the exchange of goods or services for monetary funds between two individuals or entities. In other embodiments, the transaction may be a purchase transaction involving an individual or entity purchasing goods or services from a merchant or other entity in exchange for monetary funds. In other embodiments, the transaction may be a non-financial transaction, such as exchanging of data or information between two entities, such as the transfer of data or information across a communications channel. Examples of non-financial transactions may include transactions for verifying an identity of a server computer and/or rights and restrictions associated with the server computer.

In one embodiment, a “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

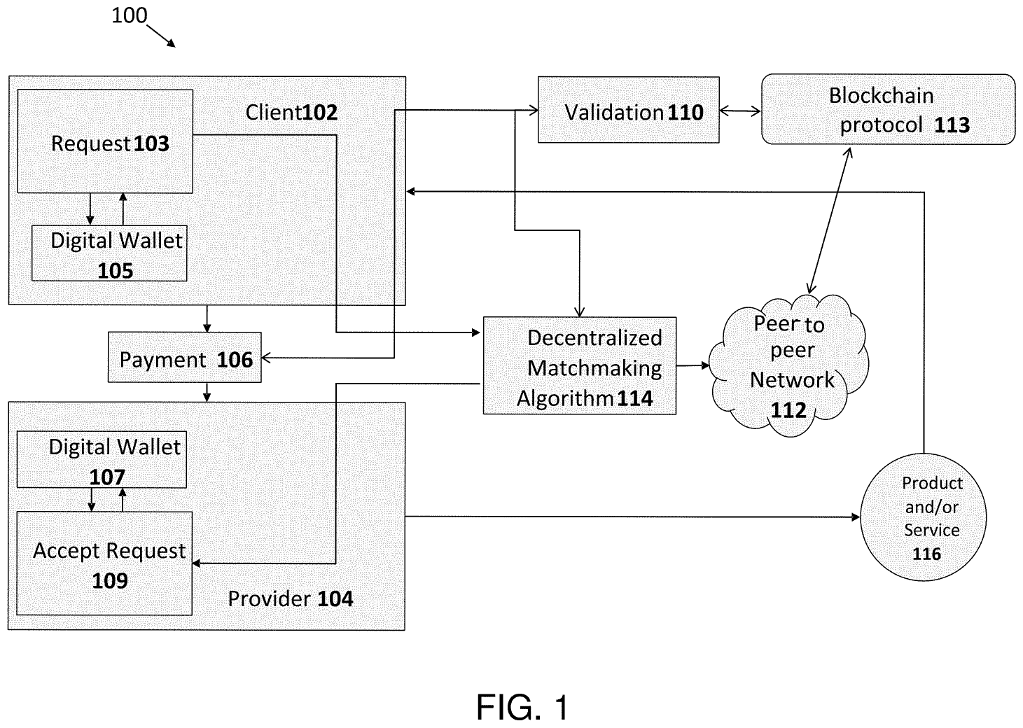

FIG. 1 shows a diagram of an example system architecture, in accordance with example embodiments of the disclosure. In another embodiment, the system architecture 100 may include users, that is, clients such as client 102 and providers such as provider 104. In another embodiment, a client 102 and a provider 104 may be linked via the system architecture 100 to perform a product or a service 116. In another embodiment, the linking via the system architecture 100 may include connecting one or more device associated with the users on a peer-to-peer network 112, where the user devices represent nodes (e.g., computational nodes) on that peer-to-peer network 112. In another embodiment, the product may include a product such as a vehicle or associated products such as tools and equipment, for example, a saw, a ladder, and the like. Further service may include, but not be limited to, a renting service, a product delivery, a rescue operation, a debris removal, and the like, that may be relevant in a given environmental context, such as a disaster (e.g., a natural disaster or a man-made disaster). In another embodiment, users of this system architecture 100 may form a localized peer-to-peer network comprising multiple clients and providers. Moreover, the number of clients and providers may increase or decrease in size to accommodate a balanced number of clients and service providers.

In another embodiment, when a client 102 makes a request 103, a decentralized matchmaking algorithm 114 may match the client 102 that made the request 103 to a provider 104 on the peer-to-peer network 112. The decentralized matchmaking algorithm 114 may use artificial intelligence algorithms and techniques, to be described below. In one embodiment, the decentralized matchmaking algorithm 114 may use the client's 102 or provider's 104 records and transaction history along with proximity and availability of the provider 104 with respect to the client 102 who made the request 103. In another embodiment, the records and transaction history, proximity, availability, and other relevant information may be stored as one or more files on the peer-to-peer network 112 in accordance with a blockchain protocol 113. Additionally, the transactions and records (e.g., client's 102 request records and/or provider's 104 product and service records) may be stored and validated on the peer-to-peer network 112 by using the blockchain protocol 113. In another embodiment, the peer-to-peer network 112 may comprise one or more computational nodes on a public infrastructure (e.g., multiple devices without restriction) or a private infrastructure (for example, computers belonging to one or more specified banks). Further, the request 103 may be delivered to the provider 104 who may accept the request 109. Accordingly, a payment 106 may be facilitated between the client's 102 digital wallet 105 the provider's 104 digital wallet 107, to be discussed further below.

In one embodiment, a digital wallet 105 may be associated with the client 102 and/or a digital wallet 107 may be associated with the provider 104. In one embodiment, the digital wallets 105 and 107 (alternatively or additionally, referred to as a e-wallet herein), may refer to an encrypted physical or virtual storage space (e.g., a block of memory on a user's device or on a device associated with e peer-to-peer network 112). In another embodiment, the digital wallets 105 or 107 may include a user's (e.g., client's 102 or provider's 104) private and public keys, which may allow the user to send and/or receive tokens (e.g., cryptocurrencies). In one embodiment, the digital wallets 105 and/or 107 may be a part of a given manufacturer or company's digital marketplace or banking functionality, thereby providing an efficient way for users (e.g., clients 102 and providers 104) to send and/or receive tokens and/or funds.

In another embodiment, the system architecture 100 having the peer-to-peer network 112 may include a validation 110 functionality that may comprise automated validators (e.g., automated clearing houses) that serve to validate the request 103, the product and/or service 116 and/or the payment 106 for the service. In another embodiment, the validation may be provided by validators including the providers 104 themselves, other nodes on the peer-to-peer network 112 such as cars, mobile devices, and other devices connected to the peer-to-peer network 112 and operating under the blockchain protocol 113.

In another embodiment, the system architecture 100 may include support for providing one or more smart contracts (not shown) and associated details on the peer-to-peer network 112 operating under the blockchain protocol 113. In particular, the smart contracts may include details of the underlying business logic and transactional details (e.g., details related to the parties involved, terms of service, terms of payment, and the like in a digital contract format) which may serve to ensure that the provider 104 will be paid by the client 102 upon successful completion of a service and/or the usage of the product (e.g., the vehicle).

In one embodiment, data (e.g., files) stored on the peer-to-peer network 112 under a blockchain protocol 113 may be distributed and replicated across the nodes of the peer-to-peer network 112, which may enable more transparency and provide additional tamper-resistance as compared with implementations not including the blockchain protocol 113. In another embodiment, the stored data may include, but not be limited to, payment history, the a provider's 104 address and the nature of the service (e.g., towing, plowing, etc.) or product (e.g., vehicle type, model, color, etc.) provided, information detailing the client's 102 request to access the data (e.g., time-stamp, device origination type, etc.), and/or a smart contract which includes aspects of the business logic to payout the a given provider 104.

In one embodiment, a profile may be generated for given users of the peer-to-peer network 112 and various financial entities (not shown) that are used to facilitate a transaction on the peer-to-peer network 112. The profile may refer to information regarding an entity. In some embodiments, the profile may be a representation of information regarding the entity, including rights and restrictions, identification data, and verification data. For example, a profile for a financial institution server computer may include data indicating the type of node the financial institution server computer is within a cryptocurrency payment network. In some embodiments, the profile may be stored in a database and be linked to an identifier associated with the entity the profile is related to. An entity may have one or more profiles. In one embodiment, a database may include any hardware, software, firmware, or combination of the preceding for storing and facilitating the retrieval of information. In addition, the database may use any of a variety of data structures, arrangements, and compilations to store and facilitate the retrieval of information.

In one embodiment, a financial institution server computer may be connected to the peer-to-peer network 112 and may be used to authorize a transaction between users (e.g., clients and providers). The financial institution server computer may refer to a computer associated with a financial institution. Examples of financial institution server computers may include an access device, terminal, or a web server computer hosting a financial institution server Internet website. The financial institution server computer may be in any suitable form. Additional examples of financial institution server computers include any device capable of accessing the Internet, such as a personal computer, cellular or wireless phones, personal digital assistants (PDAs), tablet PCs, and handheld specialized readers.

In one embodiment, a payment processing server computer (not shown) may be used to process a payment between users (e.g., clients and providers), and may be part of the financial institution server computer connected to the peer-to-peer network 112. In another aspect, the payment processing server computer may include a server computer used for payment processing. In some embodiments, the payment processing server computer may be coupled to a database and may include any hardware, software, other logic, or combination of the preceding for servicing the requests from one or more client computers. The payment processing server computer may comprise one or more computational apparatuses and may use any of a variety of computing structures, arrangements, and compilations for servicing the requests from one or more client computers. In some embodiments, the payment processing server computer may operate multiple server computers. In such embodiments, each server computer may be configured to process transaction for a given region or handles transactions of a specific type based on transaction data.

In one embodiment, the payment processing server computer may include data processing subsystems, networks, and operations used to support and deliver authorization services, exception file services, and clearing and settlement services. In one embodiment, the payment processing server computer may process transaction-related messages (e.g., authorization request messages and authorization response messages) and determine the appropriate destination computer for the transaction-related messages. In some embodiments, the payment processing server computer may authorize transactions on behalf of an issuer. The payment processing server computer may also handle and/or facilitate the clearing and settlement of financial transactions.

In one embodiment, the term “server computer” as used herein may refer to a given computer or cluster of computers connected to the peer-to-peer network 112. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

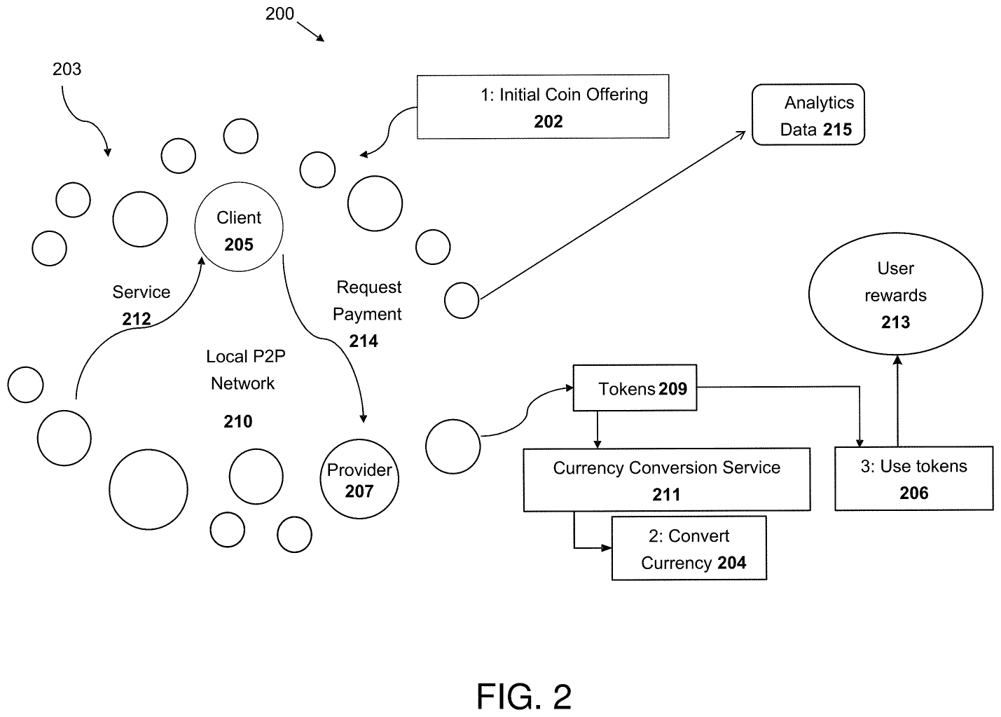

FIG. 2 shows a diagram of an example application and process flow, in accordance with example embodiments of the disclosure. In another embodiment, diagram 200 further shows a flow including aspects of payment process between users 205 (e.g., clients and providers). In an example use case, a given user 205 may request a service 212 from a provider 207 on a local peer-to-peer network comprising a plurality of nodes 203. The users 205 may request payment 214 from a provider 207. In one embodiment, the payments between the user 205 and a provider 207 may be made using a token 209, such as a cryptocurrency. In another embodiment, a given manufacturer or company associated with facilitating embodiments of the disclosure may provide an initial coin offering (ICO) 202 to facilitate the payment process. In another embodiment, the ICO 202 may include the manufacturer or company releasing an initial pool of tokens 209 to be used in the system, which the users 205 (e.g., clients and providers) can buy and sell using flat currencies (e.g., dollars, Euros, and the like) or other virtual tokens (e.g., Bitcoin, Ethereum, and the like). In another embodiment, users 205 of the local peer-to-peer network 210 may convert these tokens 209 to currency 204 either through a currency conversion service 211 provided by the given manufacturer or company, or any other (third-party) service-provider. In one embodiment, if the tokens 209 are used 206 with a given manufacturer or company, the users may obtain one or more user rewards 213, for example, from the manufacturer or company and/or from affiliate markets (e.g., discounted fuel, priority/discounted parking at private lots, discounts at auto garages, and the like). In another embodiment, the user rewards 213 (e.g., incentives and points) may also be determined based at least in part on the user's 205 records (e.g., transaction history, reputation, and the like), which may be captured as data stored on the files written to the local peer-to-peer network 210 in accordance with the blockchain protocol (not shown). In another embodiment, analytics data 215 may be generated from an analysis of the local peer-to-peer network 210 using one or more artificial intelligence-based algorithm (e.g., using machine learning). In another embodiment, the analytics data may include usage trends, demographic analysis, environmental context data, and related trends, and the like. In another embodiment, the analytics data may provide insights to a given manufacturer or company such that they may improve their service offerings. Alternatively or additionally, the analytics data 215 may be sold to one or more third-parties.

As noted above, embodiments of devices and systems (and their various components) described herein can employ (AI) to facilitate automating one or more features described herein. The components can employ various AI-based schemes for carrying out various embodiments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic-that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

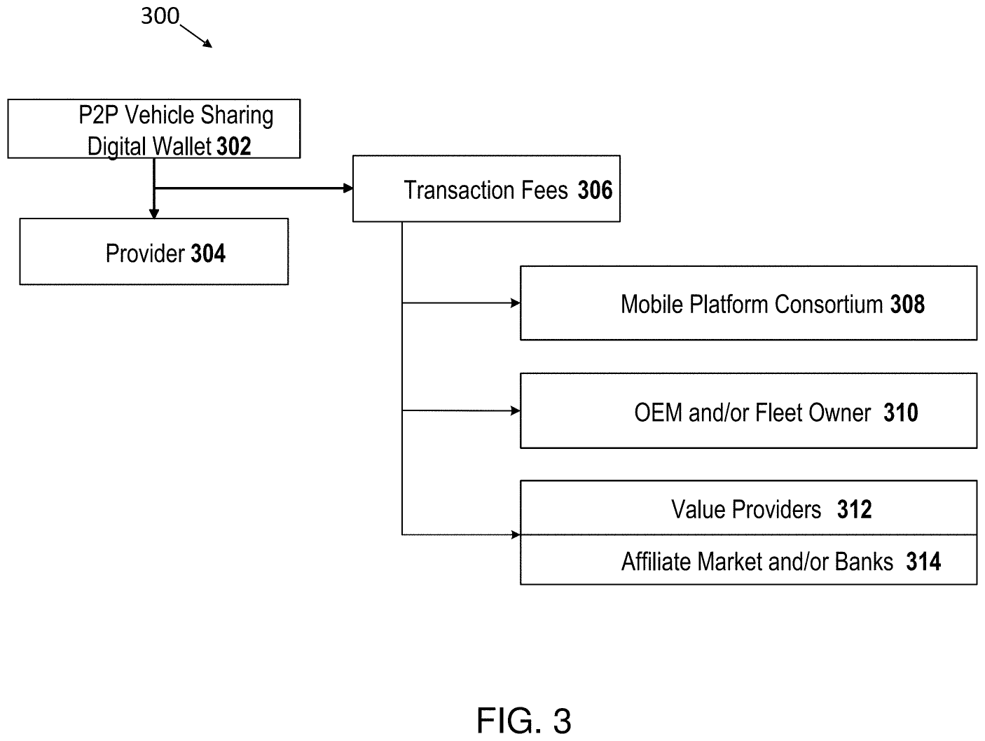

FIG. 3 shows another flow diagram for illustration business aspects, in accordance with example embodiments of the disclosure. In particular, diagram 300 shows that a peer-to-peer digital wallet 302 (similar to the digital wallets described above in connection with FIG. 2) may be used to pay providers 304 (e.g., service providers). Moreover, during the payment process, a portion of the payment (e.g., approximately 1 to approximately 5 percent of the payment) may be taken as transaction fees 306. Such transaction fees 306 may be used to at least partially fund one or more entities, including, but not limited to, a mobile platform consortium 308, an original equipment manufacturer and/or fleet owner 310, one or more value providers 312, and/or affiliate markets and/or banks 314. In this way, a variety of entities may exist in a business environment that may financially support and/or financially benefit from the localized peer-to-peer network (e.g., localized peer-to-peer network 210 of FIG. 2) and the various embodiments of the disclosure.

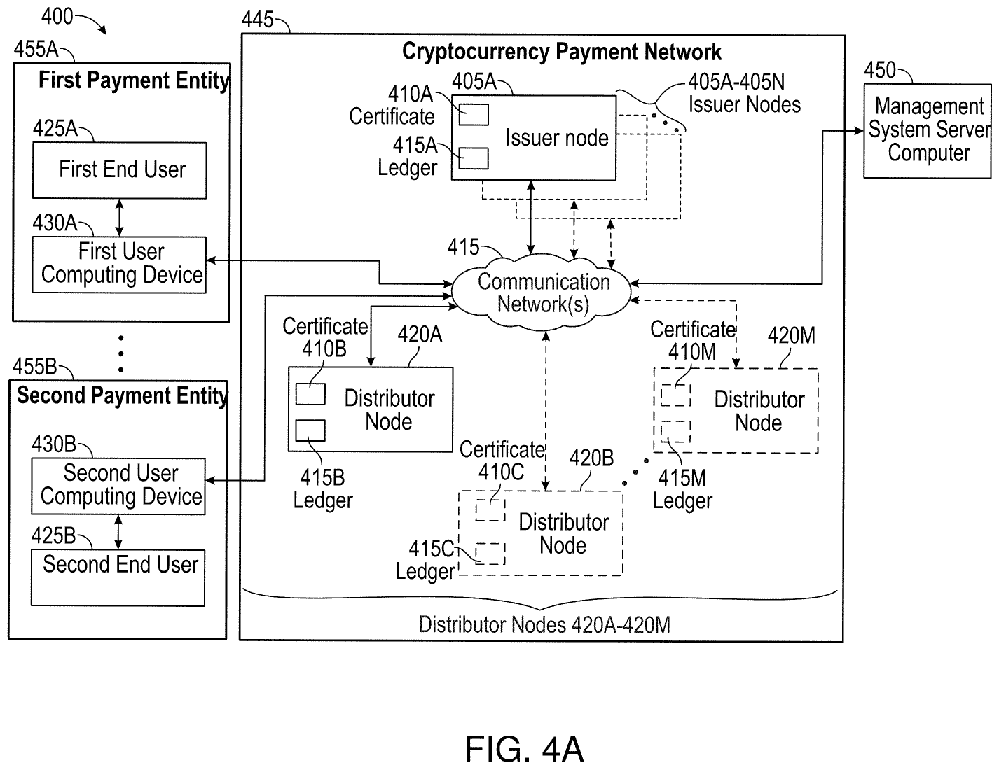

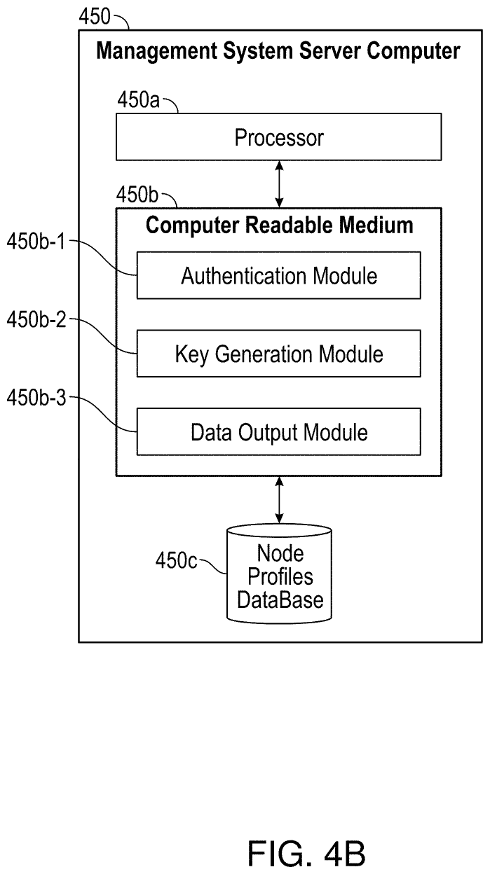

FIG. 4 shows a block diagram of an exemplary system including a cryptocurrency payment network, in accordance with example embodiments of the disclosure. The system 400 in FIG. 4 includes a cryptocurrency payment network 445 that may be connected to the peer-to-peer network (e.g., peer-to-peer network 112 shown and described in connection with FIG. 1, above) that may include a first payment entity 455A comprising a first end user 425A (e.g., a client) with a first user computing device 430A, a second payment entity 455B comprising a second end user 425B (e.g., a provider) with a second user computing device 430B, one or more issuer nodes 405A-405N, one or more distributor nodes 420A-420M, and a management system server computer 450. In some embodiments, the first end user 425A and the second end user 425B may be one of an individual user, a business entity, and an organization. Each of these systems and computers may be in operative communication with each other via any suitable communication medium (including the Internet), using any suitable communications protocol.

In the embodiment shown in FIG. 4, the systems and computers are shown to interact via one or more communication networks 415 (e.g., one or more of the Internet, private communication networks, and public communication networks). In some aspects, an example number of components are shown in system 400. It is understood, however, that embodiments of the disclosure may include more than one of each component. In addition, some embodiments of the disclosure may include fewer than or greater than all of the components shown in FIG. 4. In another embodiment, the inclusion of dotted lines indicates optional features that indicate that the number of these entities included in various embodiments may be different. Similarly, the use of “N” and “M” when referring to the issuer nodes 405A-405N and distributor nodes 420A-420M indicates that there may be any number of these entities in various embodiments, and further that there need not be the same number of issuer nodes 405A-405N and distributor nodes 420A-420M in various cryptocurrency payment network 445 configurations. In another embodiment, the user computing devices 430A-430B may be in any suitable form. For example, suitable user computing devices may be hand-held and compact so that they can fit into a user's pocket. Examples of user computing devices 430A-430B may include any device capable of accessing the Internet. Specific examples of user computing devices 430A-430B include cellular or wireless phones (e.g., smartphones), tablet phones, tablet computers, laptop computers, desktop computers, terminal computers, work stations, personal digital assistants (PDAs), physical cryptocurrency wallet hardware, pagers, portable computers, smart cards, and the like. In some embodiments of the disclosure, the user computing devices 430A-430B and a payment device associated with the user may be a single device (e.g., a mobile phone).

The user computing devices 430A-430B may include a processor and a computer readable medium coupled to the processor, the computer readable medium comprising code, executable by the processor for performing the functionality described herein. The user computing devices 430A-430B may transmit data through the communication networks 415 to issuer nodes 405A-405N, distributor nodes 420A-420M, and to the other user computing devices 430A-430B. For example, the first user computing device 430A may represent a client's device be communicatively coupled to the second user computing device 430B via the communication networks 415 to conduct a transaction with a provider (e.g., a service provider) associated with the second user computing device 430B.

In some embodiments, the cryptocurrency payment network 445 may comprise one or more server computers (not illustrated) implementing the issuer nodes 405A-405N and the distributor nodes 420A-420M. In some embodiments, each issuer node 405A-405N and distributor node 420A-420M may be a server computer associated with a separate financial institution. For example, each issuer node 405A-405N may be associated with a central bank, federal reserve, or government authority, while each distributor node 420A-420M may be associated with a different commercial bank. In various embodiments, each issuer node and/or distributor node may be implemented by a separate computing device (e.g., server computer). However, in some embodiments, a single server computer may implement multiple issuer nodes and/or distributor nodes. The issuer nodes 405A-405N and the distributor nodes 420A-420M may include a processor and a computer readable medium coupled to the processor, the computer readable medium comprising code, executable by the processor for performing the functionality described herein.

In some embodiments, each of the distributor nodes 420A-420M may be implemented by one or more server computers that maintain user profiles and/or account data (e.g., financial account data) for one or more of the end users 425A-425B. For example, in some embodiments, each of the distributor nodes 420A-420M is hosted by a respective financial institution (e.g., a bank), and thus each distributor node 420A-420M may have an explicit relationship with one or more of the end users 425A-425B through a financial account, where the end user may have provided information to the financial institution (e.g., name, address, phone number, demographic information, government identification data such as a Social Security Number (SSN), etc.).

As noted above, the cryptocurrency payment network 445 may be comprised of issuer nodes 405A-405N and distributor nodes 420A-420M in communications via the communications network 415. In some embodiments, each of these node may be granted the rights and ability to participate in the cryptocurrency payment network 445 by the management system server computer 450. In such embodiments, the management system server computer 450 may be configured to generate and distribute digital certificates, including a node verification public key, to each of the nodes to allow the nodes to function in the cryptocurrency payment network 445. The node verification public key may part of a node verification key pair, which may include a node verification private key. The node verification key pair may be an asymmetric key pair such that the node verification public key may be used to encrypt a message sent from a node to the management system server computer 450, and the corresponding node verification private key for that node may be used by the management system server computer 450 to decrypt the message.

The node verification key pair may be generated by a management system server computer 450 in response to a request message from a node to be designated an issuer node (e.g., a client's user device) or a distributor node in the cryptocurrency payment network 445. In other embodiments, the node verification key pair may be generated by a node (e.g., a provider's device and/or a financial institution server computer) and sent to the management system server computer 450. In some embodiments, node verification public keys may be sent to the issuer nodes 405A-405N and distributor nodes 420A-420M by encrypting each of the node verification public key such that only the associated node can decrypt their node verification public key.

In some embodiments, each of the issuer nodes 405A-405N and each of the distributor nodes 420A-420M may maintain a ledger 415A-415M of the payment transactions made in the cryptocurrency payment network 445. In some embodiments, the ledgers 415A-415M may include a list of transactions with each entry including a sender address, a receiver address, and an amount of digital currency for each transaction. In some embodiments, the ledger may include a record of all transactions ever performed using the digital currency.

In some embodiments, a payment transaction may only be considered official and successfully processed when the payment transaction is recorded in (all or one or more of) the ledgers 415A-415M. Thus, in some embodiments, all payment transaction messages need to be transmitted to the nodes maintaining the ledgers 415A-415M. In some embodiments, a payment entity (e.g., 455A) transmits a payment transaction message to each of the nodes maintaining a ledger, but in other embodiments the payment entity 455A may transit the payment transaction message to just one of these nodes (which in turn forwards it to the other ledger-maintaining nodes) or to another computing device specially configured to provide payment transaction messages to the ledger-maintaining nodes. In some embodiments, only a subset of the nodes may maintain a ledger (e.g., only distributor node 420B) or entirely different entities altogether may maintain the ledger.

The nodes and payment entities within the cryptocurrency payment network 445 may use a digital signature for performing transactions (e.g., transferring digital currency), which is based upon the use of digital certificate. A digital certificate, in embodiments of the disclosure, may utilize a transaction key pair (e.g., a transaction public key and a transaction private key). In some embodiments, each node can use the transaction private key to generate a digital signature (and thus, a payment message), and the node's transaction public key can be made publicly available (e.g., to other nodes in the cryptocurrency payment network 445) to allow other nodes to verify the authenticity of the payment transaction, and correspondingly record the payment transaction in their respective ledgers. In some embodiments, the transaction public key may be a “destination address” identifying a recipient of a digital currency payment.

For example, when a first payment entity 455A (e.g., a client) wishes to send digital currency to a second payment entity 455B (e.g., a provider), the first payment entity 455A generates a digital signature by: (1) creating a payment message identifying some digital currency held by the first payment entity 455A and also identifying the recipient the funds (e.g., using a transaction public key of the second payment entity 455B), (2) encrypting the payment message using the transaction private key of the first payment entity 455A, (3) and sending the encrypted payment message to the second payment entity 455B and to the other nodes in the cryptocurrency payment network 445. The other entities (e.g., nodes, payment entities, etc.) in the cryptocurrency payment network 445 may then use the transaction public key of the first payment entity 455A to verify that the amount of digital currency is valid and has been transferred to the second payment entity 455B by the first payment entity 455A. Once the transaction is verified, the transaction may be published into ledgers (e.g., ledger 415A-415M) maintained by the one or more nodes in the cryptocurrency payment network 445.

In some embodiments, an issuer node 405A may be granted a digital certificate (e.g., certificate 410A, certificate 410B, certificate 410C, . . . , certificate 410M) by the management system server computer 450. The issuer node 405A can use this digital certificate to initiate the process of generating digital currency. There are a variety of ways to generate additional digital currency, including but not limited to the issuer node 405A creating a new payment transaction to itself, and creating new payment transactions to any of the distributor nodes 420A-420M, etc. In some embodiments, these payment transactions reference completely new currency that has not previously existed until that payment transaction—the issuer nodes 405 are able to generate or invent new digital currency simply by the authority granted to it by the management system server computer 450. Embodiments of the disclosure allow for the use of many different types of digital certificates and cryptographic algorithms known to those of skill in the art, including but not limited to the use of elliptic curve digital signature algorithm (ECDSA), the secure hash algorithm (SHA) family of cryptographic hash functions (e.g., SHA-1 family, SHA-2 family, SHA-3 family, etc.), the Scrypt algorithm, etc.

In some embodiments, a distributor node 420A may also be granted a digital certificate (e.g., 410B) by the management system server computer 450. The distributor node 420A can use this digital certificate, after receiving an amount of digital currency from an issuer node 405A, to distribute an amount of the of the digital currency to one of the payment entities (e.g., 455A, 455B) or to another distributor node (e.g., 420B-420M). For example, the distributor node 420A can create a new payment transaction to the first payment entity 455A by generating a digital signature by: (1) creating a payment message identifying some of the received digital currency held by the distributor node 420A and also identifying the recipient the funds (e.g., using a transaction public key or destination address of the first payment entity 455A), (2) encrypting the payment message using the transaction private key of the distributor node 420A, (3) and sending the encrypted payment message to the first payment entity 455A and to the other nodes in the cryptocurrency payment network 445. Other entities (e.g., nodes, payment entities, etc.) in the cryptocurrency payment network 445 may then use the transaction public key of the first payment entity 455A to verify that the amount digital currency is valid and has been transferred to the second payment entity 455B by the distributor node 420A. Once the transaction is verified, the transaction may be published into ledgers (e.g., ledger 415A-415M) maintained by the one or more nodes in the cryptocurrency payment network 445.

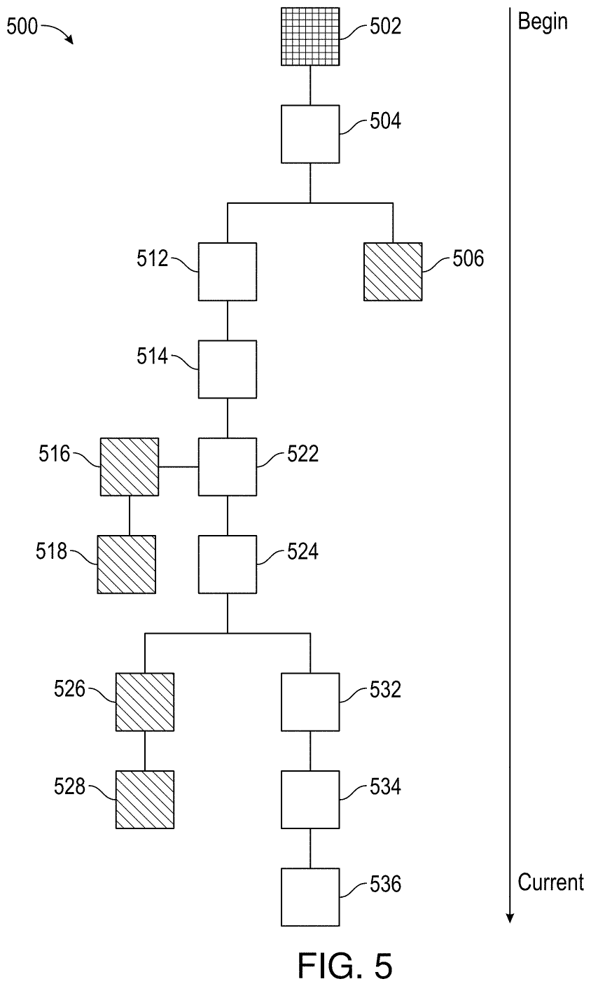

FIG. 5 is a diagram 500 illustrating an example blockchain, in accordance with example embodiments of the disclosure. In another aspect, the blockchain may be implemented via a blockchain protocol on the peer-to-peer network (e.g., peer-to-peer network 112 shown and described in connection with FIG. 1, above). Blocks in the main chain 502, 504, 512, 514, 522, 524, 532, 534, 536 may comprise the longest series of blocks that go from the beginning block 502 to the current block 536. For any block in the blockchain, there may only be one path from the beginning block 502 to the current block 536. Blocks 506, 516, 518, 526, 528 include blocks that are not in the longest chain. In another embodiment, the system may be a distributed system, such that blocks 516, 518, 526, 528 may be created only a few seconds apart from the main chain. In another embodiment, whenever a fork happens, generating computing nodes build onto which ever block is received first in time. Therefore, the short chain of blocks 516, 518, 526, 528 may not be used. In another example, each user of the blockchain in FIG. 5 may be a member. In another embodiment, after a set number of members vote on the addition of a new block in the block chain, may a block chain be added. In this member-based system, the short chains of block 516, 518, 526, 528 may not be created.

In another embodiment, the blockchain may include two kinds of records: transactions and blocks. Transactions may refer to the actual data stored in the blockchain. In another embodiment, the data in each of the blockchain may be encrypted. In one example, the data in each block may represent a single transaction. In another example, data in each block may represent more than on transaction that is dividable into sections within each block, such as, an image in series of images. Transactions are created by users or participants using the system. The blocks are recorded that confirm when and in what sequence certain transaction become journaled as back of the blockchain database.

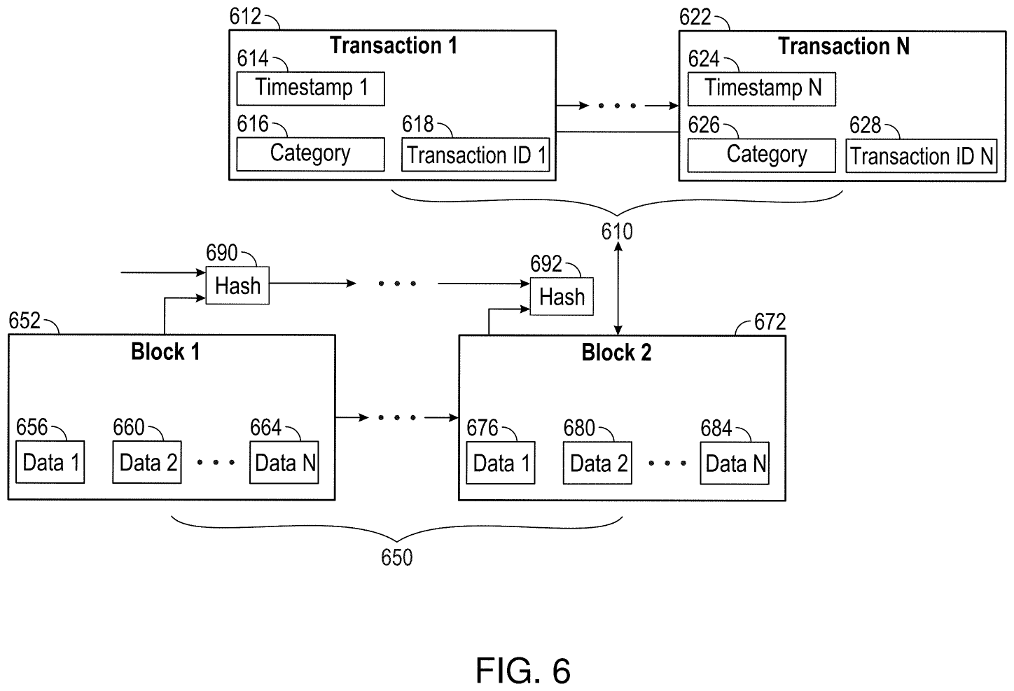

FIG. 6 shows a functional diagram 600 illustrating details of each block and transaction in a blockchain, in accordance with example embodiments of the disclosure. In particular, the diagram 600 shows two kinds of record blocks 610 and transactions 650. The transactions 650 may include data stored in the blockchain. The blocks 610 include records of transactions. In this example transactions 650 may be associated with block 2 672, while other transactions (not shown) may be associated with block 1 652.

In various aspects, record blocks 610 may represent a series of transactions 612 through 612 as shown for transaction 1 612 through transaction N 622, respectively. In another embodiment, a given record block 610 may represent a transaction and may include a timestamp (e.g., timestamp 614 or timestamp 624) of the transaction and a unique transaction identifier (e.g., transaction identifier 1 618 and transaction identifier N 628. In one embodiment, the transaction identifier can be search for a specific item in the transactional database management system. Also shown is an optional category for the transaction (e.g., category 616 for transaction 1 612, category 626 for transaction N 622), such as photo, medical, financial, employment, and the like to associate with the additional data in the transactions 650 described below.

In one embodiment, a hash function 690 and 692 is shown as part of the record blocks 610. In one implementation of a blockchain, the previously hash function 690 may be input to a subsequent hash function 692, along with the transaction 1 as shown. This may ensure that there has been no tampering or alteration of the data in the record blockchain. Transactions 650 shown in block 1 652 through block N 672 may contain user or additional data 656, 660, 664, 676, 680, 684. The additional data can represent any suitable type of data including text, audio, video, images, financial statements, and more.

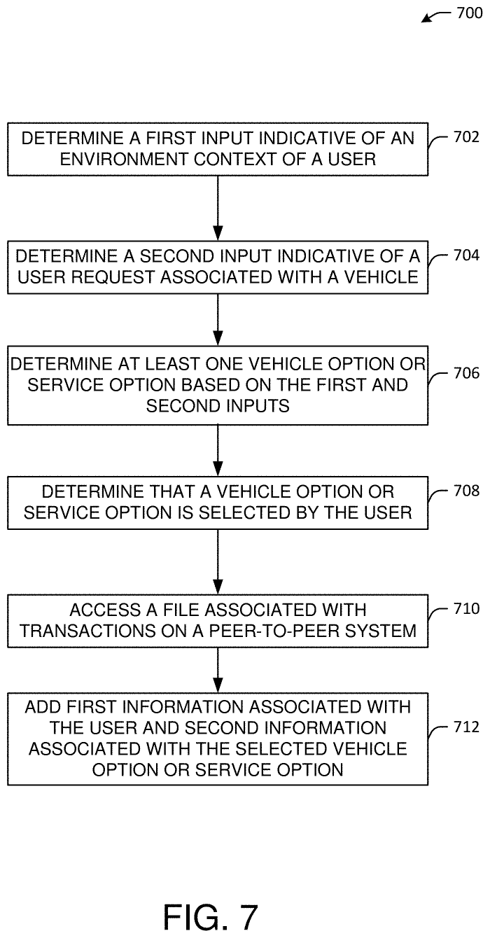

FIG. 7 shows a diagram of an example flow chart for example operations, in accordance with example embodiments of the disclosure. At block 702, a first input indicative of an environment context of a user may be determined. In one embodiment, the environment context includes a natural disaster or a man-made disaster. As noted, non-limiting examples of natural disasters may include floods, hurricanes, tornadoes, volcanic eruptions, earthquakes, tsunamis, and other geologic processes. Further, man-made disasters may include adverse events resulting from human activity, including, but not limited to, terrorism, war, cyber warfare, economic disasters, and the like. In another embodiment, the first input may include an external source or an such as weather report, a news report, a governmental alert (e.g., state of emergency alert), and the like. In another aspect, the first input may include a user input. In another embodiment, one or more AI algorithms may be used to mine news and media sources and/or social media posts and activities to determine the occurrence of a disaster associated with a given locale.

At block 704, a second input indicative of a user request associated with a vehicle may be determined. In another embodiment, the user request may include a request to share or exclusively use a vehicle for a given duration (e.g., hours, days, weeks, etc.). In another embodiment, the vehicle may be any suitable vehicle, including, but not limited to, EMT vehicles, delivery vehicles, utility vehicles, vans, and the like. Alternatively or additionally, the vehicle may include an autonomous (e.g., self-driving) vehicle.

At block 706, at least one vehicle option or at least one service option based at least in part on the first input and the second input may be determined. In another embodiment, the vehicle option may include a feature of a vehicle including, but not limited to, a hitch, a cargo capacity, an engine capacity, a four-wheel drive ability, a tire-type (e.g., snow tires), and the like. In another embodiment, the service option may include a service to help with the removal of debris, a service to help in moving equipment or various items, a service to restore power (e.g., via a backup generator), a service to provide medical aid, a service to move people to shelter, a service to move people to a hospital, a service to bring vital items (e.g., blankets, food, and the like), and other disaster relief activity.

In various embodiments, information about participating vehicles on the peer-to-peer network may also be acquired through an original equipment manufacturer (OEM) or other external entity. Such information may be used to determine the vehicle option. In one aspect, such an OEM or external entity may allow a given OEM vehicle owner to participate in the blockchain-based local peer-to-peer network without the need for the vehicle owner to create a service provider profile and/or user profile on any associated applications. In another aspect, embodiments of the disclosure may determine to suggest a given vehicle to a given client (e.g., via an app on the user device such as a mobile phone) based on one or more vehicle features, which may be provided by an OEM or other external source. Non-limiting examples include, but are not limited to, a vehicle's model, current occupancy, location, heading, engine power, fuel level, all-wheel drive capability, and the like. In another aspect, the app on the user device may be configured to suggest vehicles (for example, as part of search results displayed on the app) that have a given requested vehicle capability (e.g., capability as determined by the user), vehicle condition, and/or are a given proximity, and the like as described above, to the user. For example, if the user requests a transit van for emergency/paramedics, but a given transit van available on the peer-to-peer network services has low fuel or is occupied by goods and/or people, it may not be suggested to the user for such an urgent medical case.

At block 708, it may be determined that at least one vehicle option or service option is selected by the user. In another embodiment, the user may select the option based on an input provided to a user device, such as a mobile phone, a laptop, a computer, a tablet, and the like. In another embodiment, the user may call an emergency hotline, and a hotline operator may provide the option on behalf of the user.

At block 710, a file associated with transactions on a peer-to-peer system including computing nodes connected based on a blockchain protocol may be accessed. In an aspect, the transactions may represent a payment between the user and a provider (e.g., a vehicle or service provider). In another embodiment, the transaction may be paid using a cryptocurrency or a token that is associated with the peer-to-peer network. In one embodiment, the files may be encrypted, and the accessing of the files may be performed using a private and/or public key, as described above in connection with FIGS. 4-6.

At block 712, first information associated with the user and second information associated with the at least one vehicle option or service option may be added to the file. In another embodiment, the first information may include, but not be limited to, an age, a location, demographics, a usage history, and/or a reputation associated with the user, and the like. In one embodiment, the second information may include a vehicle identification number (VIN), a make, a model, one or more dimensions, a functionality, and/or features associated with a vehicle, and the like. In another embodiment, the addition of the information to the file may represent the recording of the transaction and related details to the ledger for a permanent record of the transaction. In another embodiment, the information recorded to the file may be mined for analysis (e.g., trend analysis) using one or more AI-algorithms, for example, to obtain data characterizing what users may need during a particular disaster. Aggregating such data from anonymized users may be obtained and transmitted to various third-parties for analysis and for optimizing resource in similar scenarios.

One or more operations of the methods, process flows, and use cases of FIGS. 1-7 may be performed by any suitable device, or more specifically, by one or more engines, program module(s), applications, or the like executable on such a device.

The operations described and depicted in the illustrative methods and process flows of FIGS. 1-7 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Example embodiments of the disclosure may include one or more of the following examples:

Example 1 may include a system, comprising at least one memory comprising computer-executable instructions; and one or more computer processors configured to access the at least one memory and execute the computer-executable instructions. The computer-executable instructions may determine an input indicative of an environment context of a user and a user request associated with a vehicle and a service; determine a vehicle based on the input; determine that the vehicle is selected by the user; access a file, wherein the file indicates transactions associated with a network, the network including computing nodes connected based on a blockchain protocol; and store first information associated with the user and second information associated with the vehicle to the file.

Example 2 may include the system of example 1, wherein the user request includes one of a request for the vehicle or the service, or a request to share the user's vehicle.

Example 3 may include the system of example 1 and/or some other examples herein, wherein the first information is used in a trend analysis using artificial intelligence, and the first information comprises at least one of an age, a location, a demographic information, a usage history, or a reputation of the user, and the first information.

Example 4 may include the system of example 1 and/or some other examples herein, wherein the second information is used in a trend analysis using artificial intelligence, and the second information includes at least one of a vehicle identification number, a make, a model, one or more dimensions, a textual description of a vehicle functionality, or a textual description of one or more features of the vehicle.

Example 5 may include the system of example 1 and/or some other examples herein, wherein the environment context is determined from an external source and includes at least one of a textual description of a natural disaster or a textual description of a man-made disaster.

Example 6 may include the system of example 1 and/or some other examples herein, wherein the one or more computer processors are further configured to access the at least one memory and execute the computer-executable instructions to cause the exchange of a token with the network, the token including a cryptocurrency or a points-based token.

Example 7 may include the system of example 6 and/or some other examples herein, wherein the points-based token is based on a model of the vehicle.

Example 8 may include the system of example 1 and/or some other examples herein, wherein the one or more computer processors are further configured to access the at least one memory and execute the computer-executable instructions to generate a smart contract.

Example 9 may include the system of example 1 and/or some other examples herein, wherein the vehicle comprises at least one of an autonomous vehicle, an emergency medical service (EMS) vehicles, a delivery vehicles.

Example 10 may include a method, comprising: determining an input indicative of an environment context of a user indicative of a user request associated with a vehicle; determining a vehicle and a service based on the input; determining that the vehicle is selected by the user; accessing a file associated with transactions on a network including computing nodes connected based on a blockchain protocol; and storing first information associated with the user and second information associated with the vehicle to the file.

Example 11 may include the method of example 10 and/or some other examples herein, wherein the user request includes one of a request for the vehicle or the service, or a request to share the user's vehicle.

Example 12 may include the method of example 10 and/or some other examples herein, further comprising using the first information in a trend analysis using artificial intelligence, and the first information comprises at least one of an age, a location, a demographic information, a usage history, or a reputation of the user.

Example 13 may include the method of example 10 and/or some other examples herein, further comprising using the second information in a trend analysis using artificial intelligence, and the second information includes at least one of a vehicle identification number, a make, a model, one or more dimensions, a textual description of a vehicle functionality, or a textual description of one or more features of the vehicle.

Example 14 may include the method of example 10 and/or some other examples herein, further comprising determining the environment context from an external source and includes at least one of a textual description of a natural disaster or a textual description of a man-made disaster.

Example 15 may include the method of example 10 and/or some other examples herein, further comprising causing the exchange of a token with the network, the token including a cryptocurrency or a points-based token.

Example 16 may include the method of example 15 and/or some other examples herein, wherein the points-based token is based on the model of the vehicle.

Example 17 may include a non-transitory computer-readable medium storing computer-executable instructions is described, which, when executed by a processor, cause the processor to perform operations comprising: determining an input indicative of an environment context of a user and a user request associated with a vehicle; determining a vehicle and a service based on the input; determining that the vehicle is selected by the user; accessing a file associated with transactions on a network including computing nodes connected based on a blockchain protocol; and storing first information associated with the user and second information associated with the vehicle to the file.

Example 18 may include the non-transitory computer-readable medium of example 17 and/or some other examples herein, wherein the user request includes one of a request for the vehicle or the service, or a request to share the user's vehicle.

Example 19 may include the non-transitory computer-readable medium of example 17 and/or some other examples, wherein the computer-executable instructions further cause the processor to cause the exchange of a token with the network, the token including a cryptocurrency or a points-based token.

Example 20 may include the non-transitory computer-readable medium of example 19 and/or some other examples herein, wherein the points-based token is based on the model of the vehicle.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. A system, comprising:
at least one memory comprising computer-executable instructions; and
one or more computer processors configured to access the at least one memory and execute the computer-executable instructions to:
determine an input indicative of an environment context of a user and a user request associated with a vehicle and a service;
determine a vehicle based on the input;
determine that the vehicle is selected by the user;
access a file, wherein the file indicates transactions associated with a network, the network including computing nodes connected based on a blockchain protocol; and
store first information associated with the user and second information associated with the vehicle to the file.

2. The system of claim 1, wherein the user request includes one of a request for the vehicle or the service, or a request to share the user's vehicle.

3. The system of claim 1, wherein the first information is used in a trend analysis using artificial intelligence, and the first information comprises at least one of an age, a location, a demographic information, a usage history, or a reputation of the user, and the first information.

4. The system of claim 1, wherein the second information is used in a trend analysis using artificial intelligence, and the second information includes at least one of a vehicle identification number, a make, a model, one or more dimensions, a textual description of a vehicle functionality, or a textual description of one or more features of the vehicle.

5. The system of claim 1, wherein the environment context is determined from an external source and includes at least one of a textual description of a natural disaster or a textual description of a man-made disaster.

6. The system of claim 1, wherein the one or more computer processors are further configured to access the at least one memory and execute the computer-executable instructions to cause an exchange of a token with the network, the token including a cryptocurrency or a points-based token.

7. The system of claim 6, wherein the points-based token is based on a model of the vehicle.

8. The system of claim 1, wherein the one or more computer processors are further configured to access the at least one memory and execute the computer-executable instructions to generate a smart contract.

9. The system of claim 1, wherein the vehicle comprises at least one of an autonomous vehicle, an emergency medical service (EMS) vehicles, a delivery vehicles.

10. A method, comprising:
determining an input indicative of an environment context of a user indicative of a user request associated with a vehicle;
determining a vehicle and a service based on the input;
determining that the vehicle is selected by the user;
accessing a file associated with transactions on a network including computing nodes connected based on a blockchain protocol; and
storing first information associated with the user and second information associated with the vehicle to the file.

11. The method of claim 10, wherein the user request includes one of a request for the vehicle or the service, or a request to share the user's vehicle.

12. The method of claim 10, further comprising using the first information in a trend analysis using artificial intelligence, and the first information comprises at least one of an age, a location, a demographic information, a usage history, or a reputation of the user.

13. The method of claim 10, further comprising using the second information in a trend analysis using artificial intelligence, and the second information includes at least one of a vehicle identification number, a make, a model, one or more dimensions, a textual description of a vehicle functionality, or a textual description of one or more features of the vehicle.

14. The method of claim 10, further comprising determining the environment context from an external source and includes at least one of a textual description of a natural disaster or a textual description of a man-made disaster.

15. The method of claim 10, further comprising causing an exchange of a token with the network, the token including a cryptocurrency or a points-based token.

16. The method of claim 15, wherein the points-based token is based on a model of the vehicle.

17. A non-transitory computer-readable medium storing computer-executable instructions which, when executed by a processor, cause the processor to perform operations comprising:
determining an input indicative of an environment context of a user and a user request associated with a vehicle;
determining a vehicle and a service based on the input;
determining that the vehicle is selected by the user;
accessing a file associated with transactions on a network including computing nodes connected based on a blockchain protocol; and
storing first information associated with the user and second information associated with the vehicle to the file.

18. The non-transitory computer-readable medium of claim 17, wherein the user request includes one of a request for the vehicle or the service, or a request to share the user's vehicle.

19. The non-transitory computer-readable medium of claim 17, wherein the computer-executable instructions further cause the processor to cause an exchange of a token with the network, the token including a cryptocurrency or a points-based token.

20. The non-transitory computer-readable medium of claim 19, wherein the points-based token is based on a model of the vehicle.
